(19) United States
(12) Patent Application Publication
(10) Pub. No.: US 2013/0255761 A1
(43) Pub. Date: Oct. 3, 2013

(54) ELECTRODE AND DYE-SENSITIZED SOLAR CELL

(71) Applicants: Grant Alexander Mathieson, Adelaide (AU); David Leslie Officer, Fig Tree (AU); Michael James Ventura, Watsonia North (AU)

(72) Inventors: Grant Alexander Mathieson, Adelaide (AU); David Leslie Officer, Fig Tree (AU); Michael James Ventura, Watsonia North (AU)

(73) Assignee: POLYMERS CRC LTD., Notting Hill, Victoria (AU)

(21) Appl. No.: 13/704,530

(22) PCT Filed: Jun. 17, 2011
(86) PCT No.: PCT/AU11/00734

§ 371 Date: Jan. 13, 2013

Related U.S. Application Data
(60) Provisional application No. 61/355,648, filed on Jun. 17, 2010.

(51) Int. Cl. H01G 9/20

(52) U.S. Cl. CPC H01G 9/2022
USPC 136/256; 438/98

(57) ABSTRACT

A working electrode and dye sensitized solar (DSSC) cell having working electrode where the working electrode includes a porous metal foil conductor and a particulate metal oxide layer on the side of the foil for facing incident light and process for preparing the electrode and

### FIELD

The invention relates to a working electrode for a dye-sensitized solar cell (DSSC) and a DSSC and method of preparation of the working electrode and DSSC.

### BACKGROUND

U.S. Pat. No. 4,927,721 and U.S. Pat. No. 5,084,365 disclose one of the first practical DSSCs (referred to as the Gratzel cell). It contained a liquid electrolyte and ruthenium dye-coated sintered titanium dioxide. The energy conversion efficiency (ECE) of this type of DSSC has been reported to be as high as 10.4% although variation in performance and reproducibility mean that typically much lower ECEs of ca 5% or less are reliably obtained. The manufacture of DSSCs typically requires a high temperature sintering process that has limited the substrate to thermally stable, rigid and light transmissible materials such as TCO-coated glass. The TCO used in such cells is relatively expensive and light transmissibility is traded off against lateral electrical conductivity. For example, a relatively thin layer of TCO with 85% light transmission may have lateral resistivity of about 15 Ω/□ whereas to achieve 10 Ω/□ lateral conductivity the light transmissibility might be reduced to about 75%.

Chinese patent 1011001929 discloses a novel class of dye-sensitized solar cell in which the working electrode comprises a stainless steel mesh upon which a porous layer of titanium dioxide (TiO₂) is deposited. When assembled with its counter electrode into a dye-sensitized solar cell (containing dye on the TiO₂ layer), the working electrode has the important advantage that it operates when illuminated with light on its front-side; that is, it operates when illuminated with light on the side not facing the counter electrode. This is different to conventional dye-sensitized solar cells, where the working electrode faces the counter electrode and is illuminated through a compromised transparent conductive layer, either the working electrode in a front-illuminated configuration, or the counter electrode in a back-illuminated configuration.

Because external electrical contact is made to a layer shaded by the working electrode, dye-sensitized solar cells of the above type are commonly referred to as “back-contact” DSSCs. They may also be termed “transparent conductive oxide-less” (TCO-less) dye-sensitized solar cells. The key advantage of such cells is that they permit both the counter electrode and working electrode to be opaque, enabling use electrode substrates made of materials with more favorable properties such as flexibility that improves manufacturability and conductivity that improves lateral charge transport in both the working and counter electrodes. They are therefore more amenable to mass production, or production of larger area cells, or both, than conventional dye-sensitized solar cells.

Numerous versions and derivatives of the above-mentioned back-contact solar cell have been described. Virtually all of them have the common feature that they employ a metallic mesh, which is typically stainless steel or titanium, as the substrate for the working electrode. The remainder employed deposition of a metallic layer, typically titanium, on the back side of porous titania attached to a light transmissible substrate.

For example, Chinese patent 1011001929 employs a stainless steel mesh, where the wire in the mesh has a 25 μm diameter. The maximum thickness of the mesh is 57 μm, with an aperture of ca. 28×28 μm². In an article entitled “Conductive mesh based flexible dye-sensitized solar cell,” in Applied Physics Letters (2007), Vol. 90, page 073501, a back-contact solar cell is described which employs a wire mesh (120 mesh) where the wire has diameter ca. 0.067 mm, with the overall thickness of the mesh being ca. 0.150 mm. An article in Applied Surface Science (2009), Vol 255, pages 9020-9025, describes a back-contact solar cell in which a mesh comprising titanium wires of ca. 0.2 mm diameter is used as the working electrode substrate. In an article in Applied Physics Letters (2009), Vol 94, page 093301, a stainless steel mesh coated with titanium metal was employed. The mesh contained wires of diameter 0.025 mm, with intervening voids of 0.025 mm×0.025 mm. In a further article in Chemistry of Materials (2008) Vol 20 pp 4974-4979, a back-contact of titanium was applied by vacuum deposition to a porous TiO₂ film on glass.

Back-contact dye-sensitized solar cells of the above types may achieve 5-8% solar efficiencies under optimum fabrication and operating conditions.

The key disadvantage of using a mesh as the substrate for the working electrode in such cells is that the mechanical and electrical attachments between intersecting strands are weak points, even in bonded mesh, and are liable to suffer damage when flexed during manufacture, installation or use.

Most recently, it has been recognized that the overall thickness of the metallic mesh employed and the size of the voids present in the mesh play a critical role in the maximum overall solar efficiency that can be achieved by the device. The device efficiency is increased when the physical distance between the dyes of the adhered TiO₂ layer and the counter electrode, via the electrolyte, is minimized. That is, the shorter the path length that must be traversed by the I⁻/I—₃⁻ electrolyte relay during the operation of the device, the more efficient it is likely to be. Additionally, the greater the area of dye-coated TiO₂ that is illuminated, the more efficient the device will be. This is because the dye-coated TiO₂ acts, fundamentally, as the light-harvesting surface of the solar cell.

Optimization of back-contact solar cells therefore involves a balance of two opposing imperatives. On the one hand, the transport distance for electrons from the titania to the lateral conductor must be minimized. On the other hand, the voids in the light-harvesting surface must be made the largest reasonably possible in order to minimize the path length of the electrolyte relay to the counter electrode. The first imperative requires a low open-area ratio or very small openings while the second imperative requires a high open-area ratio.

For example, WO 2009/075101 describes an attempt to overcome this apparent contradiction of imperatives by employing a very finely porous and thin back contact layer. A back-contact working electrode comprising of a thin layer of sputter-coated titanium metal containing pinhole voids, which were created by growing ZnO nanocrystals through the film, was fabricated. The resulting DSSC achieved 7.5% solar efficiency, demonstrating that the interplay between the void size and the size of the light-harvesting surface can have a significant effect on the overall efficiency of the device. The fabrication process employed to create the device is, however, not amenable to simple production or, indeed, to mass production.

As described in Chemistry of Materials (2008) Vol 20 pp 4974-4979, a thin back-contact of titanium was applied by vacuum deposition to a porous TiO₂ film on glass. Overall conversion efficiency of 8.4% was reported for a cell with area less than 0.25 cm². In this method of applying titanium, simultaneous porosity and lateral conductivity is achieved by applying a thin layer of relatively large titanium particles. However, for larger area cells it would be difficult to achieve sufficient porosity at the required conductivity to restrict lateral ohmic losses in the back contact layer.

The challenge that remains is therefore to devise a working electrode that allows for an optimization of the efficiency of its back-contact solar cell, whilst still providing for ease and simplicity of fabrication.

### SUMMARY

The current invention addresses this problem by utilizing a working electrode having a metallic foil substrate which has pores and a dye sorbed metal oxide on the light incident side of the metal foil.

There is further provided a method for forming a working electrode for a DSSC comprising:
providing a metal foil;
applying a particulate metal oxide layer on the side of the foil for facing incident light;
heating the particulate metal oxide and foil at an elevated temperature (preferably at least 150° C. and more preferably at least 200° C.) to form a semiconductor layer; and
sorbing a dye on the semiconductor layer and wherein the metal foil is provided with pores for charge transport via a charge transport material between the working electrode and a counter electrode.

In construction of a DSSC the method will typically further comprise: providing a transparent layer on the light incident side of the working electrode; providing a counter electrode spaced from the side of the working electrode opposite the light incident side and a providing a charge transport material between the working electrode and counter electrode.

There is provided a dye sensitized solar cell (DSSC) comprising a working electrode having a light incident side and comprising a dye sensitized metal oxide semiconductor and a conductive layer, a counter electrode spaced from the working electrode and a charge carrier material providing charge transport between the working electrode and counter electrode wherein the working electrode comprises a metal foil conductor, pores in the metal foil and the dye sensitized metal oxide semiconductor layer on the light incident side of the metal foil extending over at least a portion of the metal foil conductor.

The DSSC may, and typically will further comprise a transparent layer (preferably selected from glass and plastics material and preferably a flexible plastic material) on the light incident side of the working electrode. The transparent layer does not require a transparent conducting oxide (TCO) layer and is preferably free of a TCO.

The pores may provide the pathway for electrical transport between the metal oxide semiconductor and counter electrode via said charge carrier material.

The thinness of the foil minimizes the path length that must be traversed by the electrolyte relay; the periodic pores allow for such ionic contact. Additionally, the ratio of pores to metallic area can be readily and easily varied and the foil is amenable to simplicity of fabrication. Continuous rolls of foils are, for example, already commercially available. Such foils may be treated to have a TiO₂ surface layer in a separate process. Several such foils are amenable to sintering at high temperature, which is preferred in order to maximize the performance of the light-harvesting structures.

In one set of embodiments the working electrode comprises a metal foil selected from titanium and nickel metal foils and preferably titanium.

In one set of embodiments the metal oxide is titanium oxide which has been deposited or formed on the titanium foil and sintered on the titanium foil.

In one set of embodiments the pores constitute no more than 30% (preferably no more than 15% and most preferably no more than 10%) of the metal foil conductor's volume. At least some of the pores must be transversely contiguous, spanning opposing faces of the foil. Preferably the pores have a transverse component of alignment and most preferably the average path length through pores between opposing faces of the foil is less than twice the foil thickness.

In one set of embodiments the pores comprise at least 80% pores of size no more than 200 microns, preferably 80% are of size no more than 100 microns, still more preferably 80% are of size no more than 50 microns. In one set of embodiments 80% of the pores are no more than 20 microns such as no more than 15 microns or no more than 10 microns. In one set of embodiments the 80% of pores are of size of at least 0.005 microns such as at least 0.1 micron or at least 5 microns.

### DETAILED DESCRIPTION

The terms “pore”, “pores” and “array of pores” refers to a hole and an array of holes in the metal foil which in operation provide a passage for current generated on the light incident surface of the working electrode to pass to the counter electrode. The pores may be present in a regularly or irregularly spaced array and may pass directly through the foil (and optional supporting material) or have an irregular passage. The pores may in one embodiment be occupied by electrolyte and or semiconductor material. In the embodiment in which the metal foil conductor is deposited on a porous substrate such as a porout plastic film or porous polymeric membrane the distribution of pores may be determined by the pores on the substrate.

“Sorption” is used to designate a physical and/or chemical attachment of atoms or molecules on a surface. The term includes absorption and adsorption.

The term “transparent” is used herein to refer to materials allowing at least 50%, preferably at least about 80% visible light (having wavelength of about 400 to about 700 nm).

Throughout the description and the claims of this specification the word “comprise” and variations of the word, such as “comprising” and “comprises” is not intended to exclude other additives, components, integers or steps.

“Particles/particulate” Although there is no particular limitation on the particle size of the metal oxides forming the metal oxide layer semiconductor, the average particle size of primary particles is typically 5-400 nm and more preferably 5 to 150 nm and most preferably from 5 to 80 nm. For instance, the particulate metal oxide comprises particles of size in the range of from 5 to 400 nm. It is also possible to use a mixture of at least two metal oxides having different particle sizes to scatter incident light and increase quantum yield. In addition, the metal oxide layer may also be formed to have a two or more layered structure using two kinds of metals having different particle sizes. The metal oxides particles form the semiconductor layer to which the dye is adsorbed thus creating a light-absorbing or photo-responsive layer. The semiconductor layer is typically mesoporous and has large surface area in order to enable improved dye incorporation.

“Paste” It will be understood by those skilled in the art that the metal oxide may be applied in the form of a colloid paste of particles (typically nanoparticles), providing particle interconnectivity by sintering or some other process and/or removing of volatiles used in applying the colloid layer of metal oxide particles. Another method of applying the layer of metal oxide nanoparticles is flame spray pyrolysis. Colloidal metal oxide particles may be prepared by methods known in the art such as by hydrolysis of titanium isopropoxide. Examples of methods for preparation of colloidal titanium dioxide are described for example by Gratzel in U.S. Pat. No. 5,530,644.

The term “low temperature paste” relates to a semiconductor particulate metal oxide formulation which can be processed at temperatures usually lower than 300° C. For example, Peccell PECC-001-06 may be processed at about 150° C.

The term “high temperature paste” relates to a semiconductor particulate metal oxide formulation which can be processed at temperatures usually at least 300° C. For example, “Solaronix” Ti—Nanoxide 300 is typically processed at about 450° C.

The term “sintering” refers to the formation of interparticle connectivity that involves heating the semiconductor layer of particulate metal oxide.

The DSSC comprises a metal foil having a dye sensitized metal oxide semiconductor layer on the light incident surface of the metal foil which extends over at least a portion of the metal foil. In one set of embodiments the metal foil is selected from titanium foil and nickel foil. Titanium foil is generally preferred. In the preparation of the semiconductor the working electrode comprising the metal foil may, in one set of embodiments of the process, be subject to sintering at elevated temperature. This process may result in partial oxidation of the metal to form oxide and/or sub-oxide layers adjacent the surface. Such layers may be an advantage in providing bonding of the semiconductor to the metal foil and electron transfer or blocking contact between electrolyte and metal.

Foil porosity may be achieved either during or after formation of the foil. In one set of embodiments of the process the foil is made in a non-porous form then subsequently perforated. In another set of embodiments of the process porous titanium foil is formed by sintering a thin layer of titanium powder. The titanium powder may be mixed with a spacer material which is removed after the sintering process. In another set of embodiments of the process titanium foil is formed by compressing and sintering an assembly of randomly oriented fine titanium wires, like steel wool, into a thin, porous free-standing Ti foil. Where the porous foil is formed by sintering of fine metallic components, preferably the sintering is carried out in a non-oxidizing atmosphere.

The metal foil may be of thickness of, for example, in the range of from 5 microns to 500 microns. In one set of embodiments the foil is of thickness less than 100 microns.

The metal foil may optionally be part of an assembly including at least one film or foil of another material bonded with the metal foil. Then at least one other material of the assembly may be bonded on the side of the metal foil which is remote from the light incident side comprising the semiconductor. In the embodiment in which the foil is part of an assembly with a material bonded on the side of the foil opposite the light incident side, the material may be in the form of a coating, film, web, woven or non-woven fabric or the like. It will be understood that where the pores the of pores may extend through the assembly. For example where the material is a material is a continuous coating of film such as a polymeric film at least a portion of the pores may extend through the film to form pores through the assembly.

The assembly may be formed by bonding or laminating the foil and material. Alternatively the metal foil may be deposited on a film of material such as a plastics film or a material may be applied, for example as a coating, to the metal foil. In one embodiment the metal foil is deposited on a polymeric substrate such as a plastics film by sputter coating the polymeric substrate such as the plastics film. Other methods of metalizing plastic film such as chemical vapour deposition such as plasma enhanced CVD or cathodic arc deposition (Arc-PVD).

In one embodiment the foil is laminated with an electrically insulating porous film on the side remote from the light incident surface and at least a portion of pores extend through the film. This permits a charge relay to the counter electrode while preventing short-circuits. In one set of embodiments the insulating layer is of thickness less than 100 microns, preferably less than 50 microns. Examples of suitable insulating materials may include: tissue glass paper; fluoropolymers such as polytetrafluoroethylene (PTFE) such as sold under the Teflon® brand, porous PTFE such as sold under the Gore-Tex® or Windstopper® brands and polyvinylidene fluoride (PVDF); polymeric random copolymer poly(ethylene-co-methacrylic acid) (EMAA) such as sold under the Surlyn® brand, polycarbonates such as polycarbonate (bisphenol A polycarbonate, or (2,2-bis 4-hydroxyphenylpropane)carbonate) (PC) modified polycarbonate polycarbonate blended with other polymers, poly(phthalate carbonate) (PPC) and bisphenol A/tetramethylpolycarbonate (PC-TMPC); polyacrylates such as poly(methyl methacrylate) (PMMA) and cycloaliphatic acrylic; polyamides such as transparent polyamide(nylon) (PA-T); polyesters such as poly(ethylene terephthalate) (PET), poly(ethylene naphthalate) (PEN), polyester copolymer (copolyester) and fluorinated copolyester (O-PET); polyarylates (PAr); styrenics such as polystyrene (PS), high-impact polystyrene (HIPS), styrene-acrylonitrile copolymer (SAN), methyl methacrylateacrylonitrile-butadienestyrene copolymer (MABS) and advanced styrenic copolymers; polyetherimides; sulfone polymers such as polysulfone (PSU), poly(ether sulfone) (PES) and poly(phenyl sulfone) (PPSU); poly(ether imide) (PEI); polyimides, such as Kapton H or Kapton E (made by Dupont) or Upilex (made by UBE Industries, Ltd.); polynorbornenes; olefinics such as cyclo-olefinic copolymer (COC), cyclo-olefinic polymer (COP) and clarified polypropylene; liquid crystal polymers (LCP) such as polyetheretherketone (PEEK), polyethylene terephthalate (PET), polyethylene naphtalate (PEN); Poly(phenylene ether) (PPE), poly(phenylene oxide) (PPO), Rigid thermoplastic polyurethane (PUR-R); optically transparent thermosetting polymers including: diethylene glycol bis(allyl carbonate) or allyl diglycol carbonate (CR39); other ophthalmic resins based on sulfur containing monomers, urethane monomers, halogenated aromatic diallyl, divinyl or dimethacrylyl monomers; and other optical polymers such as fluorinated polyimide (PI-f) and poly(methylpentene) (TPX) or products such as Barix™ barrier film.

The DSSC of the invention may be flexible wherein the component such as the working electrode, counter electrode, electrolyte and any other materials allow the DSSCs to be flexed, for example in a continuous roll. One of the problems of providing a flexible DSSC is that flexing may cause either an electrical short from contact between the working electrode and counter electrode or an increase in spacing leading to lower efficiency. This is particularly a problem where the electrolyte is a liquid or soft material. An assembly comprising the metal foil and a polymeric material in the form, for example, of a film web or fabric (e.g. non-woven fabric) on the side of the foil remote from the light incident surface may be used to provide and effective electrical insulation between the foil and counter electrode so a to avoid creating an electrical short when the DSSC is flexible.

The semiconductor of the working electrode is located on the light incident surface of the foil. The semiconductor is generally formed of a particulate metal oxide may for instance selected from the group consisting of metals of Groups IB, NA, INA, NIB, IVA, IVB, VA, VB, VIA, VIB and VIII. Preferably, the metal is selected from the group consisting of Mg, Ca, Sr, Ba, Sc, Y, La, Ti, Hf, V, Nb, Ta, Cr, Mo, W, Fe, Ni, Cu, In, Al and Ga. The preferred metal oxide comprises one or more of, for example, titanium oxide, niobium oxide, tungsten oxide, indium oxide, iron oxide, tin oxide, nickel oxide, and strontium titanate, most preferably titanium oxide, niobium oxide, tungsten oxide, indium oxide, tin oxide, nickel oxide, and the like, but is not necessarily limited thereto. Of these metal oxides titanium oxide is the preferred metal oxide semiconductor particularly in embodiments of the invention in which the foil is titanium foil.

Specific examples of the metal oxide include TiO₂, SnO₂, WO₃, Fe₂O₃, Nb₂O₅, NiO and SrTiO₃, in particular TiO₂, SnO₂, WO₃, Nb₂O₅, NiO and SrTiO₃, especially TiO₂ and SnO₂.

As the dye in the present invention, any material may be used without any particular limitation as long as it is one compatible with use in the photovoltaic cell field.

According to a further embodiment, the interconnected nanoparticle material is coated with a photosensitizing agent (such as a dye) that includes a molecule selected from the group consisting of anthocyanins, squarates, eosins, xanthines, cyanines, merocyanines, phthalocyanines, indolines, porphyrins, oligothiophenes, coumarins, perylenes and pyrroles.

According to another embodiment the photosensitizing agent is a metal complex that includes a metal atom or ion selected from the group consisting of multivalent metals. Preferably this metal complex is selected from the group consisting of a ruthenium transition metal complex, an osmium transition metal complex, and an iron transition metal complex. In one illustrative embodiment, the photosensitizing agent is adsorbed (e.g. chemisorbed and/or physisorbed) on the interconnected nanoparticles. The photosensitizing agent may be adsorbed on the surfaces of the interconnected nanoparticles throughout the interconnected nanoparticles or both. The photosensitizing agent is selected, for example, based on its ability to absorb photons in a wavelength range of operation, its ability to produce free electrons in a conduction band of the interconnected nanoparticles and its effectiveness in complexing with or adsorbing onto the surface of the interconnected nanoparticles. Suitable photosensitizing agents may include, for example, dyes that include functional groups, such as carboxyl and/or hydroxyl groups, which can chelate to the nanoparticles, e.g., to Ti (IV) sites on a TiO₂ surface. Examples of suitable dyes include, but are not limited to, anthocyanins, squarates, eosins, xanthines, cyanines, merocyanines, phthalocyanines, indolines, porphyrins, oligothiophenes, coumarins, perylenes and pyrroles, and metal-containing dyes such as ruthenium complexes like RuL₂(SCN)₂, RuL₂(H.₂O)₂, RuL₃, and RuL₂, wherein L represents 2,2′-bipyridyl-4,4′-dicarboxylate and the like.

For example, cis-bis(isothiocyanato)bis(2,2′-bipyridyl-4,4′-dicarboxylato)-ruthenium (II) (“N3 dye”); tris (isothiocyanato)-ruthenium (II)-2,2′:6′,2″-terpyridine-4,4′, 4″-tricarboxylic acid (“black dye”); cis-bis (isothiocyanato) bis(2,2′-bipyridyl-4,4′-dicarboxylato)-ruthenium (II) bis-tetrabutylammonium (“N719 dye”); cis-bis (isothiocyanato)(2,2′-bipyridyl-4,4′-dicarboxylato) (2,2′-bipyridyl-4,4′-di-nonyl)ruthenium(II) (“Z907 dye”); and tris(2,2′-bipyridyl-4,4′-dicarboxylato)ruthenium (II) dichloride, all of which are available from Solaronix. Further suitable dyes are those known as indoline dyes such as 5-[[4-[4-(2,2-diphenylethenyl)phenyl]-1,2,3,3a,4,8b-hexahydrocyclopent[t(]indol-7-yl]methylene]-2-(3-ethyl-4-oxo-2-thioxo-5-thiazolidinylidene)-4-oxo-3-thiazolidineacetic acid, 5-[[4-[4-(2,2-diphenylethenyl)phenyl]-1,2,3,3a,4,8b-hexahydrocyclopent[b]indol-7-yl]methylene]-2-(3-ethyl-4-oxo-2-thioxo-5-thiazolidinylidene)-4-oxo-3-thiazolidineacetic acid (“D149 indoline dye”).

Any dye may be used as long as it has a charge separation function and shows photosensitivity and binds to the metal oxide particulate layer.

The DSSC of the invention comprises a charge carrier material or electrolyte layer which may be of the type known in the art. The charge carrier may be a liquid, gel, salt or solid electrolyte. The charge carrier material may be any material that facilitates the transfer of electrical charge from a ground potential or a current source to the interconnected nanoparticles (and/or a dye associated therewith). A general class of suitable charge carrier materials can include, but is not limited to solvent based liquid electrolytes, polyelectrolytes, polymeric electrolytes, solid electrolytes, n-type and p-type transporting materials (e.g., conducting polymers, functionalized arylamines, SpiroMeOTAD, organic charge carrier materials, etc), and gel electrolytes, which are described in more detail below.

Other choices for the charge carrier material are possible. For example, the electrolyte composition may include a lithium salt that has the formula LiX, where X is an iodide, bromide, chloride, perchlorate, thiocyanate, trifluoromethyl sulfonate, or hexafluorophosphate. In one embodiment, the charge carrier material includes a redox system. Suitable redox systems may include organic and/or inorganic redox systems. Examples of such systems include, but are not limited to, cerium (III) sulfate/cerium (IV), sodium bromide/bromine, lithium iodide/iodine, Fe²VFe³⁺, Co²VCo³⁺, and viologens. Furthermore, an electrolyte solution may have the formula M|Xⱼ, where i and j are greater than or equal to: 1. X is an anion, and M is selected from the group consisting of Li, Cu, Ba, Zn, Ni, lanthanides, Co, Ca, Al, and Mg. Suitable anions include, but are not limited to, chloride, perchlorate, thiocyanate, trifluoromethyl sulfonate, and hexafluorophosphate.

For instance, the electrolyte is iodide/iodine in a (e.g. suitable) solvent such as acetonitrile.

In some illustrative embodiments the charge carrier material includes a polymeric electrolyte. In one version, the polymeric electrolyte includes polyvinyl imidazolium halide) and lithium iodide. In another version, the polymeric electrolyte includes polyvinyl pyridinium salts). In still another embodiment, the charge carrier material includes a solid electrolyte. In one version, the solid electrolyte includes lithium iodide and pyridinium iodide. In another version, the solid electrolyte includes substituted imidazolium iodide. In another version, the solid electrolyte includes (2,2′,7,7′-tetrakis-(N,N-di-p-methoxyphenylamine)-9,9′-spirobifluorene), f-butyl pyridine and bis((trifluoromethane)sulfonamide lithium salt.

According to some illustrative embodiments, the charge carrier material includes various types of polymeric polyelectrolytes. In one version, the polyelectrolyte includes between about 5% and about 100% (e. g. , 5-60%, 5-40%, or 5-20%) by weight of a polymer, e.g., an ion-conducting polymer, about 5% to about 95%, e.g., about 35-95%, 60-95%, or 80-95%, by weight of a plasticizer and about 0.05 M to about 10 M of a redox electrolyte, e.g., about 0.05 M to about 10 M, e.g., 0.05-2 M, 0.05-1 M, or 0.05-0.5 M, of organic or inorganic iodides, and about 0.01 M to about 1 M, e.g., 0.05-5 M, 0.05-2 M, or 0.05-1 M, of iodine. The ion-conducting polymer may include, for example, polyethylene oxide (PEO), polyacrylonitrile (PAN), certain acrylics, polyethers, and polyphenols. Examples of suitable plasticizers include, but are not limited to, ethyl carbonate, propylene carbonate, mixtures of carbonates, organic phosphates, butyrolactone, and dialkylphthalates.

The DSSC may, and typically will comprise a transparent light incident layer on the light incident side of the working electrode. The transparent layer may be formed of any suitable transparent material such as glass polymer film or the like.

Examples of suitable polymeric material for use as a transparent light incident layer include may include: random copolymer poly(ethylene-co-methacrylic acid) (EMAA) such as sold under the Surlyn® brand, polycarbonates such as polycarbonate (bisphenol A polycarbonate, or (2,2-bis 4-hydroxyphenylpropane) carbonate) (PC) modified polycarbonate polycarbonate blended with other polymers, poly(phthalate carbonate) (PPC) and bisphenol A/tetramethylpolycarbonate (PC-TMPC); polyacrylates such as poly(methyl methacrylate) (PMMA) and cycloaliphatic acrylic; polyamides such as transparent polyamide (nylon) (PA-T); polyesters such as poly(ethylene terephthalate) (PET), poly(ethylene naphthalate) (PEN), polyester copolymer (copolyester) and fluorinated copolyester (O-PET); polyarylates (PAr); styrenics such as polystyrene (PS), high-impact polystyrene (HIPS), styrene-acrylonitrile copolymer (SAN), methyl methacrylateacrylonitrile-butadienestyrene copolymer (MABS) and advanced styrenic copolymers; polyetherimides; sulfone polymers such as polysulfone (PSU), poly(ether sulfone) (PES) and poly(phenyl sulfone) (PPSU); poly(ether imide) (PEI); polyimides, such as Kapton H or Kapton E (made by Dupont) or Upilex (made by UBE Industries, Ltd.); polynorbornenes; olefinics such as cyclo-olefinic copolymer (COC), cyclo-olefinic polymer (COP) and clarified polypropylene; liquid crystal polymers (LCP) such as polyetheretherketone (PEEK), polyethylene terephthalate (PET), polyethylene naphtalate (PEN); Poly(phenylene ether) (PPE), poly(phenylene oxide) (PPO), Rigid thermoplastic polyurethane (PUR-R); optically transparent thermosetting polymers including: diethylene glycol bis(allyl carbonate) or allyl diglycol carbonate (CR39); other ophthalmic resins based on sulfur containing monomers, urethane monomers, halogenated aromatic diallyl, divinyl or dimethacrylyl monomers; and other optical polymers such as fluorinated polyimide (PI-f) and poly(methylpentene) (TPX) and products such as Barix™ barrier film.

The DSSC may be prepared by a range of methods having regard to the structure described above.

The method of preparing the DSSC, in one set of embodiments, comprises:
forming a working electrode comprising providing a metal foil;
applying a particulate metal oxide on the side of the foil facing incident light;
heating the particulate metal oxide and foil at an elevated temperature (preferably at least 150° C. and more preferably at least 200° C.) to form a semiconductor layer; and sorbing a dye on the semiconductor layer;
and wherein the metal foil is provided with pores for electrical communication between the working electrode and a counter electrode.

The method typically further comprises providing a transparent layer on the light incident side of the working electrode; providing a counter electrode spaced from the side opposite the light incident side of the working electrode; and providing a charge carrier material between the working electrode and counter electrode.

In one set of embodiments the metal oxide is applied as a paste which comprises an organic material. The paste may be applied to create a continuous film on the charge transport portion of the metal foil. Following deposition, the resultant film is heated to remove the organic material. The temperature of this organic binder removal is typically between 50° C. and 500° C. which is determined by the composition of the binder and the nature of the substrate.

As the working electrode is based on a metal conductor one of the significant advantages of the working electrode is that it can be prepared at relatively high temperatures compared with flexible transparent material such as plastics. Accordingly this allows the metal oxide semiconductor to be formed on the surface of the metal foil by sintering, for example, at a temperature of at least 300° C., such as at least 350, at least 380 and at least 400. In the case of titania semiconductor sintering in the range of from 400° C. to 500° C. such as 400° C. to 450° C. may produce a particularly efficient semiconductor.

When the working electrode is an assembly comprising a material on the side remote from the light incident surface the material may be applied before or after sintering of the metal oxide to for the semiconductor. The specific order of construction will depend on the nature of the non-conductive material and the sintering temperature used in preparation of the semiconductor. For example if the non-conductive material is a low melting plastic it may be applied after the sintering step at relatively high temperature or alternatively sintering may be conducted at a temperature lower than the melting point of the material. For example low temperature pastes of metal oxide, that is pastes which are applied and sintered at, for example no more than 200° C. such as no more than 150° C. may be used in preparation of the semiconductor although their efficiency is in most cases not as good as semiconductors formed by sintering at relatively high temperature such as about 400° C. to 450° C.

The pores may be formed in the metal foil (or assembly including another material, where the material is a continuous film such as a polymer) either before, during or after application and sintering of the metal oxide to form the semiconductor. In some embodiments the time of creating the pores may have a bearing on the material which is located in the pores during operation of the cell. For example application of metal oxide to a foil having the array of pores may allow control of the placement of the metal oxide over the pores and depending on the relative sizes of the pores and metal oxide particles the extent of penetration of metal oxide particles into the array of pores.

### BRIEF DESCRIPTION OF THE DRAWINGS

A small number of preferred embodiments of the present invention are described hereinafter, by way of example only, with reference to the accompanying drawings in which:

FIG. 1 is a schematic view of a dye sensitized solar cell according to an embodiment of the invention;

FIG. 1a is a schematic view of a cross section of a portion of the working electrode of FIG. 1;

FIG. 2 is a schematic cross section view of a dye sensitized solar cell of a further embodiment of the invention;

FIG. 2a is a schematic view of a cross section of the working electrode of the DSSC of FIG. 2;

FIG. 3 is a flowchart illustrating a method for fabricating a dye sensitized solar cell according to an embodiment of the invention;

FIG. 4 Example 1 schematic cross section showing working electrode facing outward toward incident light;

FIG. 5 is a photograph showing working electrode of Example 1 embodiment facing outward toward incident light;

FIG. 6 is a graph showing Current-Voltage curves—two results above 4% efficiency at AM 1.5 (1 Sun) illumination, plus dark current curve for the embodiment of Example 1;

FIG. 7 is schematic showing working electrode of Example 2 facing outward toward incident light;

FIG. 8 is a photograph of the embodiment of Example 2 showing working electrode facing outward toward incident light;

FIG. 9 is a graph showing Current-Voltage curves—two results above 3% efficiency at AM 1.5 (1 Sun) illumination for the embodiment of Example 2.

FIG. 10 is schematic showing working electrode of Example 3a facing outward toward incident light;

FIG. 11 is a photograph of the embodiment of Example 3a showing working electrode facing outward toward incident light;

FIG. 12 is a graph showing Current-Voltage curves at AM 1.5 (1 Sun) illumination for the embodiment of Example 3a;

FIG. 13 is a graph showing Current-Voltage curves at AM 1.5 (1 Sun) illumination for the embodiment of Example 3b;

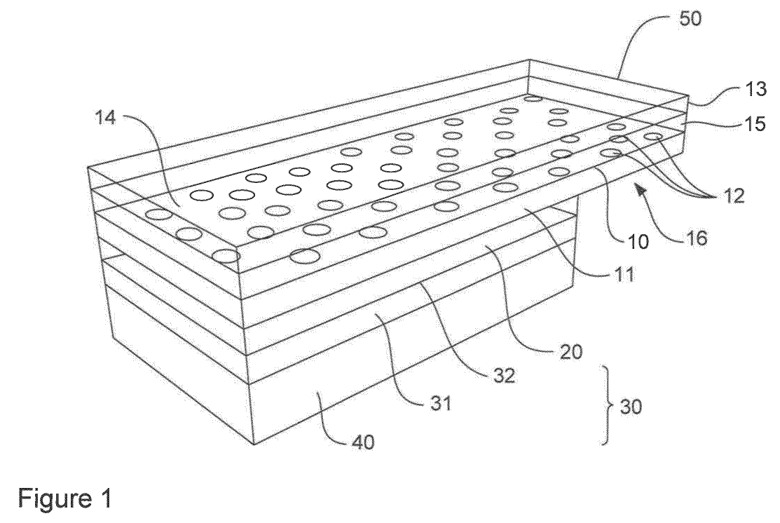

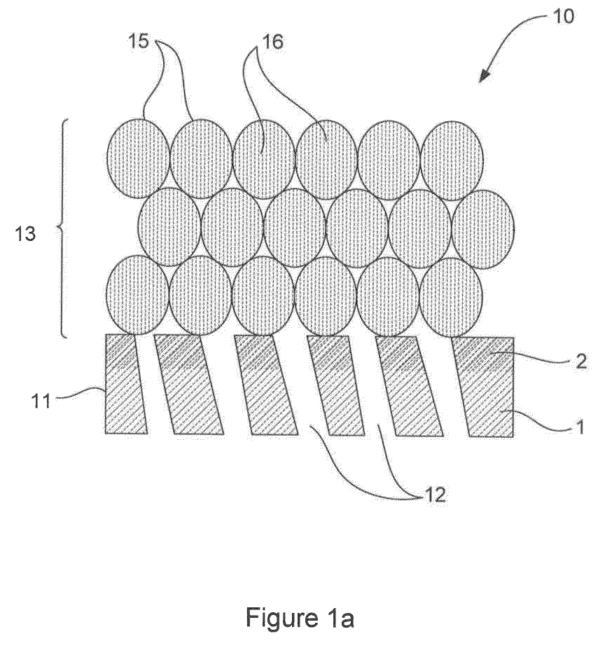

Referring to FIG. 1 a DSSC has a working electrode (10)(also shown separately in FIG. 1a) which has a metal foil (11) of titanium, aluminium or other suitable metal with an of pores (12) extending through the foil and a metal oxide semiconductor layer (13), comprising sintered metal oxide particles (16), on the light incident side (14) of the porous portion (12) of metal foil (11) on which a layer of dye (15) is sorbed. A charge transfer material (20) provides charge transport between the working electrode (10) and counter electrode (30), comprising a metal foil (31) and a catalytic titania layer in contact with the charge transfer material, on the side of the foil (16) remote from the light incident side (14). A transparent light incident layer (50) may be provided as protection on the light incident side of the dye sorbed semiconductor layer (14) and the counter electrode side of the DSSC may be supported on a back support (40) such as an electrically insulating material which may allow the DSSC to be used in conjunction with a metallic substrate such as a metallic roofing component.

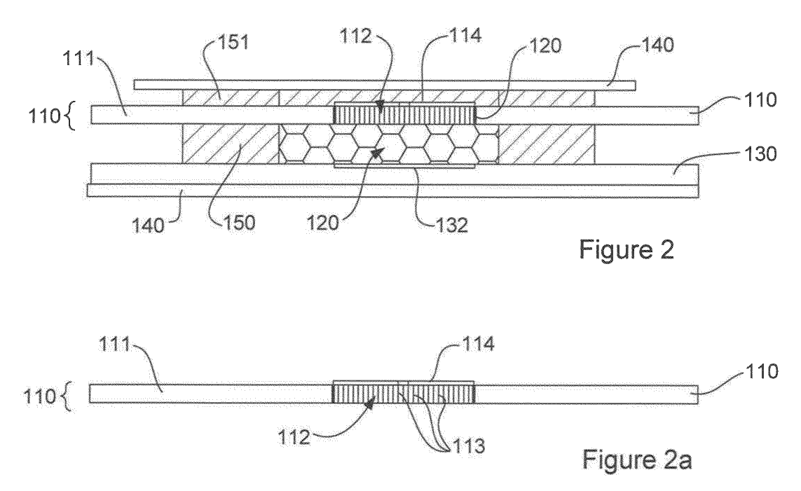

Referring to FIG. 2 a further embodiment of a DSSC (100) has a working electrode (110) (also shown in FIG. 2a) which is made up of a metal foil (111) such as titanium which has a current generating portion (112) provided with an array of pores (113) extending through the foil (111) and which current generating portion(112) is provided on the light incident side of the foil (111) with a dyed semiconductor layer (114) formed by sintering of a particulate metal oxide and sorption onto the semiconductor of a dye.

A charge transfer material (120) provides charge transport between the working electrode (110) and counter electrode (130), comprising a metal foil (131) and a catalytic metal oxide (e.g. titania) layer (132) which provide high surface area particularly in the portion opposed to the current generating portion (112) of the working electrode (110), in contact with the charge transfer material (120) on the side of the foil (116) remote from the light incident side (115). A transparent light incident layer (140) may be provided as protection on the light incident side of the dye sorbed semiconductor layer (114) and the counter electrode (130) side of the DSSC may be supported on a back support (140) such as an electrically insulating material which may allow the DSSC to be used in conjunction with a metallic substrate such as a metallic roofing component. Seals (150 and 151) may be provided at the periphery of the current generating portion of the working electrode and light incident layer (140) to maintain the required spacing (150) between the metal foil and transparent light incident layer to accommodate the dyed semiconductor (114) and between the metal foil (111) and counter electrode (130) to provide spacing (151) to accommodate the charge transfer material (120).

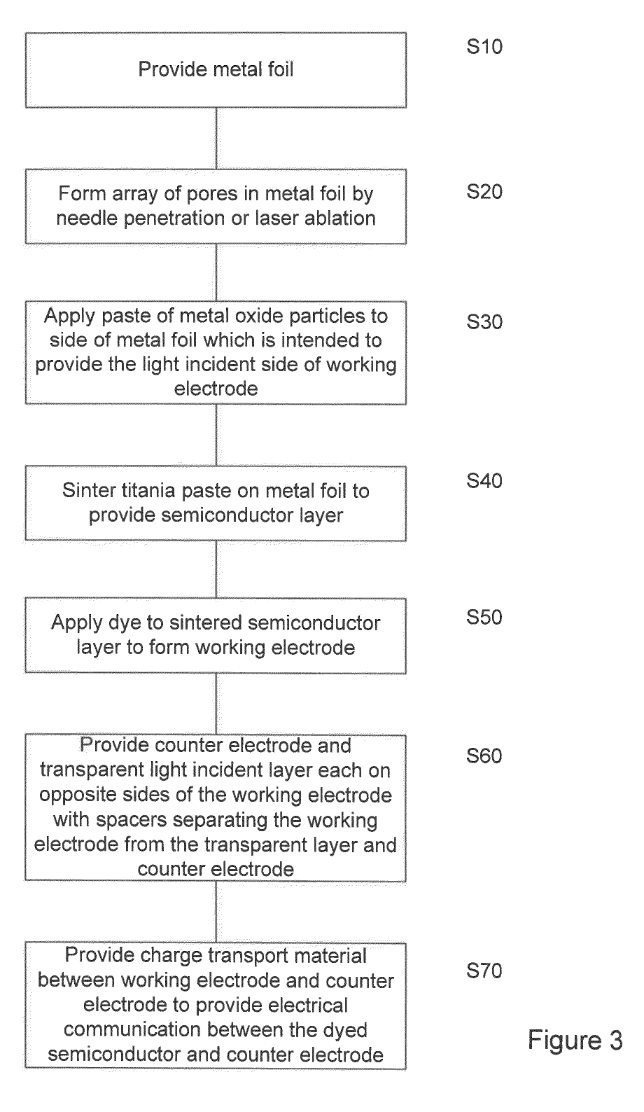

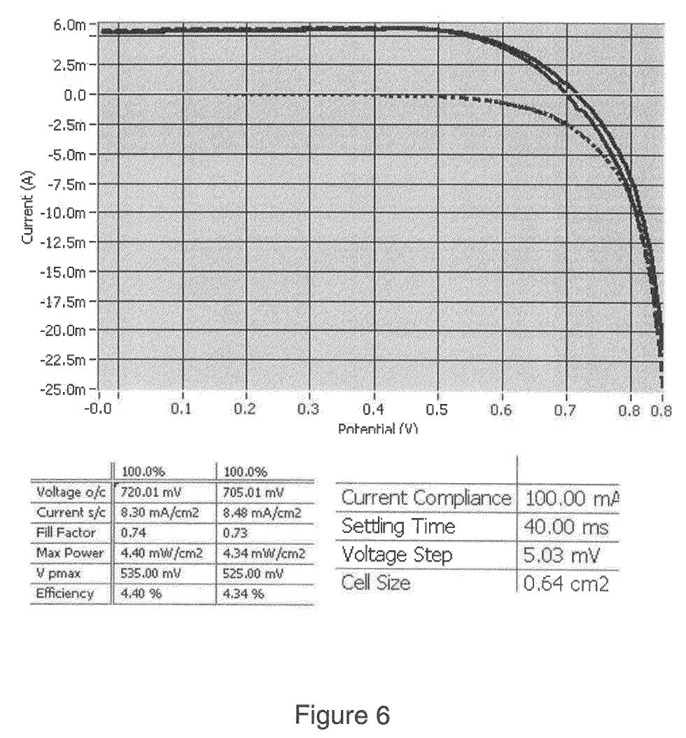

FIG. 3 is a flowchart illustrating a method of fabricating a DSSC according to one set of embodiments. Referring to FIG. 2 and FIG. 6 a working electrode (110) is first prepared by a method outlined in operations S10 to S50. A metal foil (111) is provided in operation S10 in which an array of pores (113) is formed by penetration of needles or laser ablation in operation S20. The array of pores may be formed in a portion (112) of the foil (111) intended to form at least part of the current generating portion (112). The foil (111) may, for example, provide a single working electrode (110) or may be continuous with current generating working electrodes (110) formed at spaced areas along the foil.

A paste of particulate metal oxide (preferably titania) is applied to the side of the foil which is to provide the light incident side of the working electrode in operation S30 and the paste may be adapted for low temperature sintering (for example at less than 300° C.) or more preferably a higher temperature paste for sintering at, for example at least 300° C., such as 350° C. to 550° C., 400° C. to 500° C. or 400° C. to 450° C. The metal foil may be part of a laminate with a plastics material in which case a low temperature paste may be used and sintering conducted at a temperature lower than the softening point of the plastic. The paste is sintered in operation S40 at the desired temperature and the resulting semiconductor treated with a dye in operation S50 to form a working electrode having sorbed layer of dye on the semiconductor.

A transparent light incident layer is provided on the light incident side of the working electrode and a counter electrode is spaced from the side of the foil remote from the light incident side and spacers are provided between the foil and transparent layer and foil and counter electrode in operation S60 and charge transport material is provided between the foil and counter electrode.

The invention will now be described with reference to the following examples. It is to be understood that the examples are provided by way of illustration of the invention and that they are in no way limiting to the scope of the invention.

### EXAMPLES

The first two examples used titanium foil perforated by a laser. The laser parameters were: femtosecond pulsed laser (Spectra Physics Spitfire); 1 kHz repetition rate; wavelength 800 nm; focused with a 0.14 NA objective. The fabrication conditions were: 800 mW power at the back aperture of the objective; with an exposure time of 0.01 sec per spot.

### Example 1

This Example demonstrates the production of a back contact cell using titanium foil as both working and counter electrode substrates with additional rigid front and back supports was prepared according to the following production flow chart.

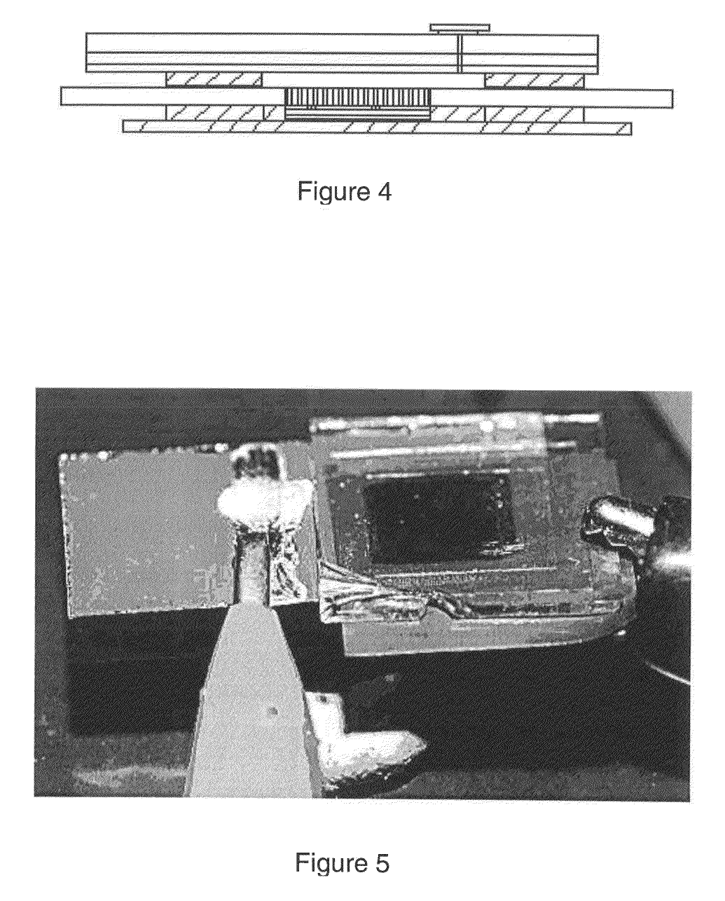

The resulting back contact dye sensitized cell comprising the working electrode is shown schematically in FIG. 4 and the a picture is shown in FIG. 5 with the working electrode facing upward toward incident light. The performace of the cell was examined using the arrangement shown in FIG. 5 and FIG. 6 is a graph showing Current-Voltage curves—two results above 4% efficiency at AM 1.5 (1 Sun) illumination, plus dark current curve for the embodiment of Example 1

### Example 2

Example 2 demonstrated production of a back contact cell using titanium foil as both working and counter electrode substrates with flexible front sealing layer and rigid back support

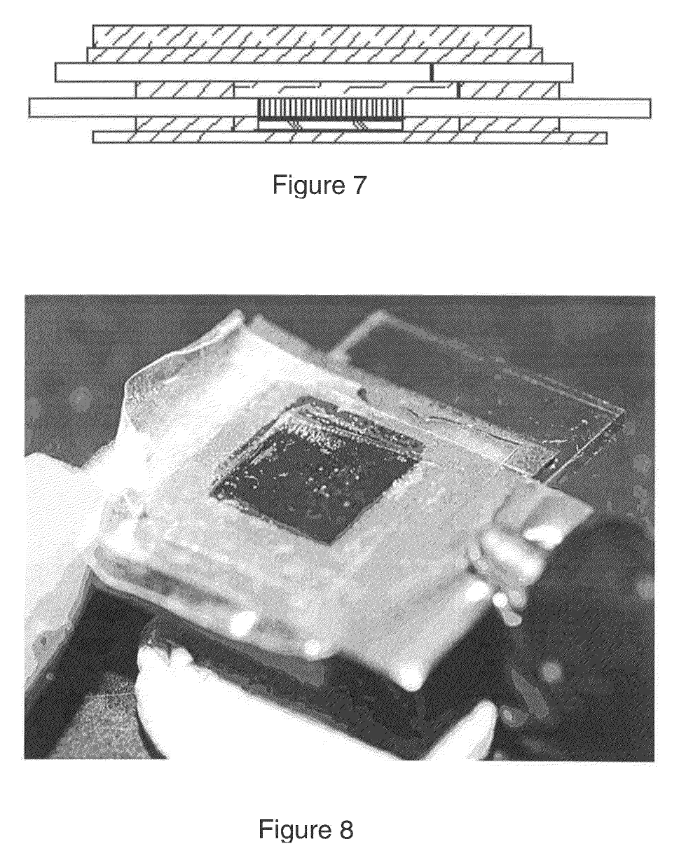

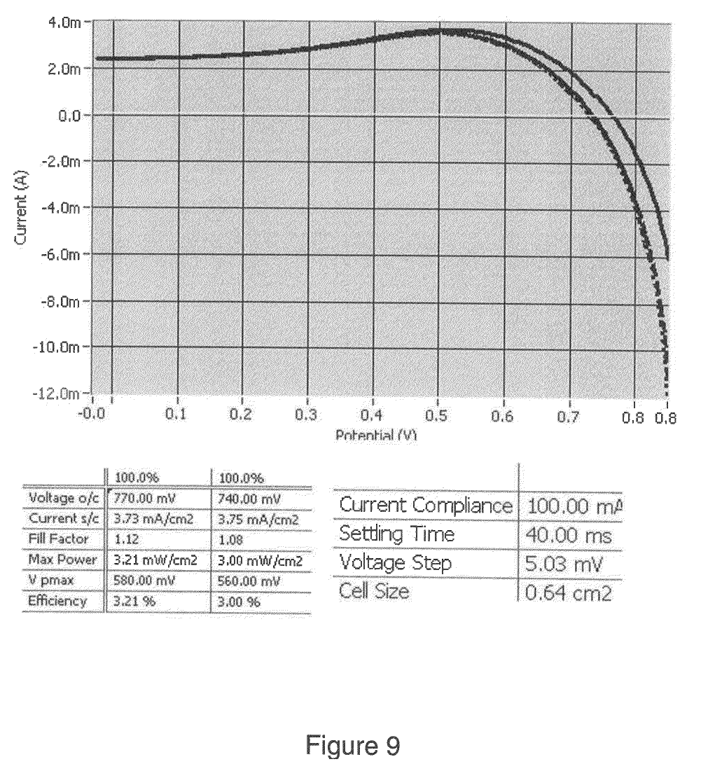

The resulting back contact dye sensitized cell comprising the working electrode is shown schematically in FIG. 7 and a picture is shown in FIG. 8 with the working electrode facing upward toward incident light. The performance of the cell was examined using the arrangement shown in FIG. 8 and FIG. 9 is a graph showing Current-Voltage curves—two results above 3% efficiency at AM 1.5 (1 Sun) illumination, plus dark current curve for the embodiment of Example 1

### Example 3

### Back Contact Cell Using Porous Separator as Substrate

Example 3a relates to a back contact cell using porous separator as working electrode substrate with additional rigid front and back supports.

Example 3b relates to a back contact cell using porous separator as both working electrode and counter electrode substrates with additional rigid front and back supports

This Example demonstrates the formation of a working electrode and back-contact dye sensitised solar cell DSSC using an insulating porous separator-substrate on which the metal foil conductor is formed by sputter coating made in two forms: a) porous separator-substrate for working electrode only; and b) porous separator-substrate for both working and counter electrodes. For a) with a photoanode made by sputtering about 1 micron of commercially pure grade 1 Ti (cp1 Ti) onto a porous PVDF, commercially available Millipore brand 0.1 micron hydrophilic filter membrane, about 100 microns thick with m.p. 177° C. and void fraction 70%. In this sense the separator was both a substrate and template for deposition of Ti metal. The sputter coater was an Edwards Auto 306 with Edwards FTM6 controller and Advanced Energy MDX 1.5K magnetron drive. An Ar plasma was used and either 2×10⁻² or 1.5×10⁻³ mbar Ar pressure was used. Denser Ti was made at lower pressure. Sputtering power of 40 W was used. The porosity of the template was on the scale of 1 micron and the sputtered titanium partly obscured the membrane. The porosity of the Ti was on the scale of 0.1 micron. Solaronix low temperature paste Ti-Nanoxide T-L was subsequently doctor bladed and heat treated to 150° C. resulting in a porous layer about 1 micron thick. The cell was assembled according to the following production flow chart. In Example 3 part b) the working electrode was constructed in the same way. The counter electrode the back side of the PVDF membrane was sputtered using the same sputter coating system with Pt at 30 W sputtering power for 30 mins to create a catalytic layer which was then sandwiched to a Ti foil counter-electrode. Assembly was performed similarly to type a).

### Example 3a

A porous separator-supported working electrode was prepared and used to form a DSSC in accordance with the following flow chart.

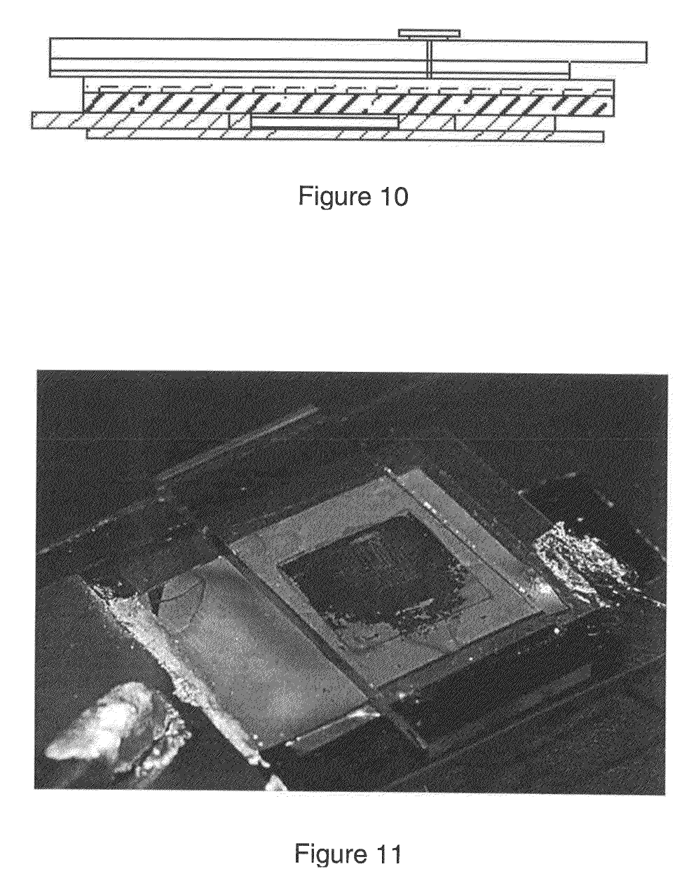

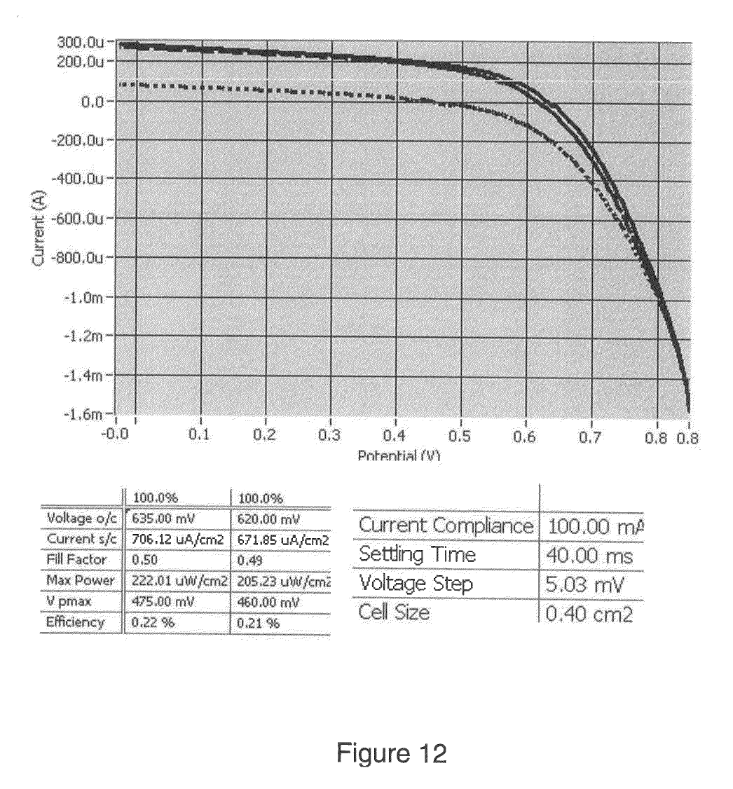

The resulting back contact dye sensitized cell comprising the working electrode is shown schematically in FIG. 10 and a picture is shown in FIG. 11 with the working electrode facing upward toward incident light. The performance of the cell was examined using the arrangement shown in FIG. 11. FIG. 12 is a graph showing Current-Voltage at AM 1.5 (1 Sun) illumination, plus dark current curve for the embodiment of Example 3a

### Example 3b

A porous separator-supported working and counter electrodes were prepared and used to form a DSSC in accordance with the following flow chart.

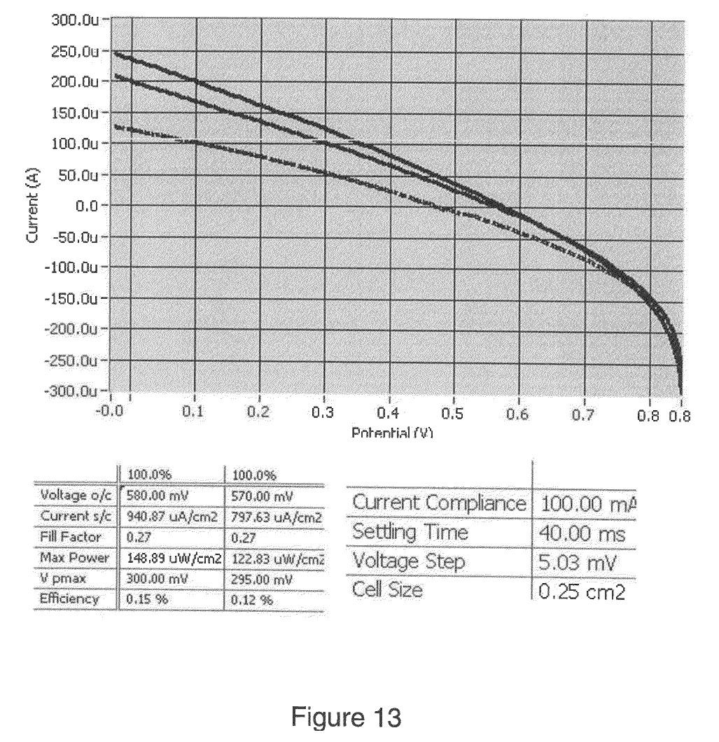

The performance of the cell was examined using the arrangement corresponding to that shown in FIG. 11. FIG. 13 is a graph showing Current-Voltage curves at AM 1.5 (1 Sun) illumination, plus dark current curve for the embodiment of Example 3a

Surlyn® is a trademark of DuPont and here refers to a random copolymer poly(ethylene-co-methacrylic acid) (EMAA) which may be produced by free radical polymerisation.

1. A method for forming a working electrode for a dye sensitized solar cell comprising:
providing a metal foil;
applying a particulate metal oxide layer on the side of the foil for facing incident light;
heating the particulate metal oxide and foil at an elevated temperature to form a semiconductor layer; and
sorbing a dye on the semiconductor layer and wherein the metal foil is provided with pores for charge transport via a charge transport material between the working electrode and a counter electrode.

2. A method of preparing a dye sensitized solar cell comprising a working electrode of claim 1 comprising:
forming a working electrode comprising:
providing a porous metal foil;
applying particulate metal oxide particles on the side of the foil for facing incident light;
heating the metal oxide and foil at an elevated temperature to form a semiconductor layer extending over at least a portion of the pores;
sorbing a dye on the semiconductor later;
providing a transparent layer on the light incident side of the working electrode and a counter electrode spaced from the side opposite the light incident side of the working electrode and a charge carrier material there between for charge transport between the working electrode and counter electrode.

3. A method according to claim 1 wherein the pores are formed by means of microneedles or by laser.

4. A method according to claim 1 wherein the metal oxide is printed onto the surface of the metal foil.

5. A method according to claim 1 wherein the applied metal oxide is formed electrochemically at the surface of the metal foil using the metal foil as the precursor.

6. A method according to claim 1 wherein the metal oxide is applied mechanically to the surface of the metal foil.

7. A method according to claim 1 wherein the metal oxide is applied and is sintered on the metal foil at a temperature of from 300° C. to 500° C.

8. A method according to claim 1 wherein the metal foil is a titanium foil, the metal oxide is titania and the metal oxide is sintered on the metal foil at a temperature of from 400° C. to 500° C.

9. A method according to claim 1 wherein the metal foil is part of an assembly including at least one film of another material which is electrically insulating, bonded with the metal foil on the side of the metal foil which is remote from the light incident side and wherein pores extend through the film to form pores through the assembly.

10. A method according to claim 9 wherein the assembly is formed by depositing a metal foil on a plastic film.

11. A method according to claim 9 wherein the assembly is formed by depositing a metal foil on an electrically insulating material which is porous.

12. A method according to claim 9 wherein the metal foil is deposited on a porous film of plastics material by a method selected from the group consisting of sputter coating, chemical vapour deposition or cathodic arc deposition (Arc-PVD).

13. A dye sensitized solar cell (DSSC) comprising a working electrode having a light incident surface and comprising a dye sensitized metal oxide semiconductor and a conductive substrate layer, a counter electrode spaced from the working electrode and a charge carrier material providing charge transport between the working electrode and counter electrode wherein the working electrode comprises a metal foil conductor, pores in the metal foil and the dye sensitized metal oxide semiconductor layer on the light incident side of the metal foil extending over at least a portion of the metal foil.

14. A DSSC according to claim 13 further comprising a transparent layer free of transparent conductive oxide layer, on the light incident side of the working electrode.

15. A DSSC according to claim 13 wherein the pores provide a pathway for electrical transport between the metal oxide semiconductor and counter electrode via said charge carrier material.

16. A DSSC according to claim 13 wherein the metal foil is titanium foil and the metal oxide semiconductor is titania.

17. A DSSC according to claim 13 wherein the pores constitute no more than 20% of the porous surface area of the metal foil.

18. A DSSC according to claim 13 wherein at least 80% of the pores are of size in the range of from 0.5 to 200 microns.

19. A DSSC according to claim 13 wherein the pores comprise pores spaced by a distance at least twice the diameter of the pores.

20. A DSSC according to claim 13 wherein the metal foil is of thickness in the range of from 5 microns to 500 microns.

21. (canceled)

22. A DSSC according to claim 13 wherein the metal foil is part of an assembly including an electrically insulating a plastics material bonded with the metal foil on the side of the metal foil which is remote from the light incident side and wherein pores extend through the film to form pores through the assembly.

23. (canceled)
